(19) United States
(12) Patent Application Publication
(10) Pub. No.: US 2024/0255375 A1
(43) Pub. Date: Aug. 1, 2024

(54) TIGHTNESS TESTING OF VACUUM PACKAGES

(71) Applicant: ALBERT HANDTMANN MASCHINENFABRIK GMBH & CO. KG, Biberach (DE)

(72) Inventors: Peter BORKUS, Hösbach (DE); Martin BERGMANN, Hösbach (DE)

(21) Appl. No.: 18/564,585

(22) PCT Filed: May 10, 2022
(86) PCT No.: PCT/EP2022/062624

§ 371 Date: Nov. 29, 2023

(30) Foreign Application Priority Data
May 27, 2021 (DE) 10 2021 113 754.3

(51) Int. Cl. G01M 3/36

(52) U.S. Cl. CPC G01M 3/363

(57) ABSTRACT

The present invention relates to a testing station for testing for the tightness of one or more vacuum packages, where each of the one or more vacuum packages has an initial spatial dimension at a reference pressure, comprising a negative pressure generating device which is configured to act upon the one or more vacuum packages from the outside with the test pressure which is reduced in comparison to the reference pressure, and a sensor system which is configured to determine, based on a change in the spatial dimension of at least one of the one or more vacuum packages during the application of the test pressure relative to the respective initial spatial dimension of the one or more vacuum packages, whether at least one of the one or more vacuum packages is leaking.

### TECHNICAL FIELD

The present invention relates to a device and method for testing for the tightness of vacuum packages, in particular for testing for the tightness of vacuum packages in-line. Vacuum packages are used, for example, in the food industry.

### TECHNOLOGICAL BACKGROUND

To date, there are no sufficiently reliable and efficiently implemented methods or systems in prior art that test the tightness of the vacuum packages produced during the ongoing production process (in-line). In particular in the food industry, undetected leaks in the vacuum packages have catastrophic consequences on product quality because, for example, the packaged food can spoil. The tightness of the vacuum package also serves as a guarantee of product quality, for example, the guarantee of the integrity or sterility of the sealed contents.

Furthermore, the tightness of the vacuum package can also be important in sectors other than the food industry. Outside the food industry, vacuum packages are used, for example, to protect against oxidation, corrosion, mechanical damage (e.g. scratches), electrostatic discharge (use of ESD film), moisture absorption, contamination (e.g. in sterile products), etc. of the packaged products. Vacuum packages are also used to affix components in loose assemblies (e.g. separable rolling bearings).

In the food industry, vacuum packages are typically verified manually by testing, in particular scanning, by hand each individual vacuum package and by staff visually inspecting the weld seam of the vacuum packages. The verification often takes place in the so-called “black area” of the production process. This means that products with a leaky package are classified as confiscated and must be disposed of—in contrast to the “white area”, in which products with a leaky package can be returned to the packaging system.

On the one hand, this cannot ensure reliably enough that vacuum packages with leaks are discharged. Another serious drawback is that the manual testing process is time-consuming and labor-intensive. Vacuum package production and testing is often integrated into a large production line where manual vacuum package testing cannot keep up with the manufacturing cycle.

### BRIEF DESCRIPTION OF THE INVENTION

An object of the present invention is to overcome the drawbacks of prior art. It is in particular the object of the invention to provide a testing station and a testing method for testing for the tightness of vacuum packages which no longer requires staff to manually test the tightness of the vacuum packages. A further object is to provide a testing station and a testing method for testing for the tightness of vacuum packages which enables the tightness of the vacuum packages in an ongoing production process (in-line) and preferably is or can be adapted to the production cycle.

The invention is particularly suitable for use in the food industry, for example, for testing for the tightness of a vacuum package of sausage or meat products. The invention can be used both in the white area as well as in the black area of production. In principle, the invention can be employed to test the tightness of vacuum packages in sectors other than the food industry, i.e. the vacuum-packed products are not confined to food.

The basic idea of the present invention is the use of sensors, in particular the substitution of manual inspection by hand with an intelligent sensor-supported and/or automated test for the tightness of the vacuum packages.

The invention makes use of the physical principle that, when a vacuum package is subjected to a test pressure that is reduced in comparison to a reference pressure, e.g. atmospheric pressure, then the spatial dimension of the vacuum package changes. If the vacuum package is leaky, it expands, whereas, if the package is tight and/or undamaged, the spatial dimension of the package does not change (substantially). This change in the spatial dimension of the package can be easily recorded and evaluated using a sensor system. The sensor data obtained in this manner can be used to conclude the tightness of the vacuum package. The result of the tightness testing can be used, for example, to initiate further measures such as declaring the tested vacuum package and package found to be leaking as being discard and/or discharging it from the production line.

According to one aspect of the present invention, a testing station for testing for the tightness of one or more vacuum packages is provided. The testing station can be configured to test several vacuum packages simultaneously, i.e. in one testing process or test cycle, respectively. The one or more vacuum packages to be tested have an initial spatial dimension at a reference pressure. The reference pressure is basically to be understood to be a pressure that is higher than the test pressure. For example, the reference pressure is the atmospheric pressure that prevails at the location of the testing station.

The initial spatial dimension of the one or more vacuum packages can be determined, for example, by measurement. Alternatively, it is also possible to read out the initial spatial dimension of the vacuum package(s) from a database or to store it by an operator using a user interface. The test pressure is preferably chosen such that a detectable expansion of the vacuum package at the test pressure can occur.

The testing station comprises a negative pressure generating device which is configured to subject the one or more vacuum packages from the outside to a test pressure that is reduced in comparison to the reference pressure by lowering the pressure in the test room from the reference pressure to the test pressure. The test pressure in the test room can be reduced, for example, in the range of 0.03 MPa to 0.08 MPa in comparison to the reference pressure. The evacuation time of the test room can there be adapted to the production cycle of the production line. For example, the test room can be evacuated in less than 5 s, for example, within 0.5 s to 1.0 s, in order to adjust the test pressure.

The testing station further comprises a sensor system which is configured to determine, based on a change in the spatial dimension of at least one of the one or more vacuum packages during the application of the test pressure relative to the respective initial spatial dimension of the one or more vacuum packages, whether at least one of the one or more vacuum packages is leaking. The sensor system can be able to detect a change in the spatial dimension either in one spatial axis, in two spatial axes, or in all three spatial axes. A change in the spatial dimension in one of the spatial axes can indicate a leaking vacuum package.

In an exemplary embodiment, the testing station comprises a housing that defines a test room in which the one or more vacuum packages are acted upon with the test pressure. The negative pressure generating device can be configured to generate the test pressure in the test room. The negative pressure generating device lowers the reference pressure to the test pressure. The housing can be part of the negative pressure generating device. Alternatively, the housing can be manufactured separately from the negative pressure generating device, where the negative pressure generating device is associated with the housing such that it can apply the test pressure in the test room.

From a structural point of view, the test room can be a space that is in particular gas-tight and/or fluid-tight and/or separated from the environment and which is defined by the housing at least in sections, in particular, for the largest part. The test room can also be referred to as an evacuation chamber which is evacuated when negative pressure is applied. The design and shape of the evacuation chamber can depend on the nature, size, and quantity of the vacuum packages to be tested. In principle, the volume of the evacuation chamber can be selected to be as small as possible in order to leave as little dead space as possible around the vacuum package(s) to be tested. This allows the evacuation time of the evacuation chamber to be reduced. Another approach is to provide a large-volume universal chamber so that it can be employed regardless of the nature and/or size of the vacuum package(s) to be tested. One or more filler members adapted to the vacuum package to be tested can be inserted into the universal chamber to limit the dead space. The filler pieces can be exchanged in the form of interchangeable members when the product is changed.

The housing of the evacuation chamber is to be configured to be as light as possible and as stable as necessary. Materials suitable for the housing of the evacuation chamber are PC, acrylic, GRP and/or carbon, possibly with a suitable coating, in particular for food processing. To ensure sufficient rigidity, curvatures, edge and corner radii, as well as rib structures are preferable to reinforcing the wall thicknesses. Support elements in the form of columns, strips, etc. can be required for evacuation chambers with a large footprint.

In a further exemplary embodiment, the negative pressure generating device comprises a first working state, hereinafter also referred to as the testing process, in which it applies the test pressure in the test room. The pressure in the test room can be lowered from the reference pressure to the test pressure. The negative pressure generating device furthermore comprises a second working state, hereinafter referred to as the initialization state, in which it applies the reference pressure in the test room. The negative pressure generating device does not necessarily have to directly generate or apply the reference pressure itself. The negative pressure generating device can ensure also in the initialization state that the reference pressure builds up in or is applied in the test room. For example, the negative pressure generating device can ensure that the ambient pressure or atmospheric pressure is established in the test room in the initialization state.

According to a further exemplary embodiment, the testing station comprises a support for the one or more vacuum packages which interacts with the housing for fluid-tight, in particular gas-tight, definition of the test room. The vacuum packages can be provided on the support. The support can be flexible. Furthermore, the support can be formed from a material that is transparent, i.e. penetrable, to the sensors. For example, the several vacuum packages can be positioned on the support, in particular in a predetermined arrangement relative to one another. For example, two adjacent vacuum packages can be arranged offset from one another in a conveying direction of the vacuum packages through the testing station and/or transverse to the conveying direction.

The support can be formed by a conveying system. Conveying systems, also known as conveying devices, are generally machines and systems that are used to convey goods to be conveyed, presently the vacuum packages to be tested. The conveying system can cyclically transport the vacuum packages to be tested, in accordance with a particular predetermined cycle, which is adapted, for example, to a production cycle for producing vacuum packages, or continuously, i.e. in particular non-interrupted and/or at a constant conveying speed. The test cycle of the testing station overall, as well as the evacuation time of the test room, can be selected based on the production cycle specified in order to enable inline testing of the vacuum packages that keeps pace with the production cycle.

The conveying system can be associated with the negative pressure generating device in such a way that the former transfers the individual vacuum packages to the negative pressure generating device or is part of the negative pressure generating device. For example, the conveying system comprises a conveyor belt, a rotary indexing table, a sliding table, or the like. The surface and structure of the support, in particular of the conveyor belt, can be selected as a function of the nature of the goods conveyed. The conveyor belt is to be formed to be sufficiently rigid and gas-tight or fluid-tight, respectively. The nature of the conveyor belt surface should be smooth or finely structured and little reflective. In an exemplary further development, the negative pressure can be generated from below the conveyor belt. A perforated conveyor belt with an appropriate substructure can be used.

Furthermore, the conveying system can convey the vacuum package to be tested continuously or cyclically along a conveying direction and the negative pressure generating device can be mounted to be movable such that the negative pressure generating device can move accordingly along with the vacuum package conveyance. The conveyance via the conveying system and the testing of the vacuum packages for tightness can take place without the conveying system halting or stopping the conveyance of the vacuum packages to be tested. It is alternatively possible for the negative pressure generating device to be arranged in a fixed or stationary manner and for the conveying system to be clocked and/or coordinated with the duration of the testing process of an individual vacuum package and to stop during each testing process.

In an exemplary further development, the testing station according to the invention comprises a gantry robot which is configured to move the negative pressure generating device in accordance with the vacuum package conveyance. For example, the gantry robot can be a line/linear gantry, in particular with two axes. It is then not necessary to interrupt the conveyance across the conveying system. In other words, the negative pressure generating device travels with the conveying system and in particular with the vacuum packages arranged thereon and to be tested. Testing the tightness of the vacuum package(s) can therefore be carried out in-line during the ongoing production process. For example, the gantry robot runs along an in particular predetermined motion cycle which represents a testing process (testing cycle) of the at least one vacuum package. Once a testing process has been completed, the motion cycle starts again and at least one further vacuum package is tested.

For example, the housing can comprise a seal associated with the support for gas-tight and/or fluid-tight closure of the test room during the testing process. The seal can be, for example, a profile lip seal. The seal can be produced from elastic and/or elastomeric material. The degree of hardness of the seal can depend on the surface nature of the contact surfaces (support, housing). Other sealing options include round cord seals (O-rings), for example, in a housing groove, injected silicone seals or flat seals that are glued to the housing.

Furthermore, the housing can be transparent or permeable to microwaves, at least in part. For example, transparent vacuum packages are common in the food industry so that their contents can be seen. The transparency of the housing can therefore be greater than the transparency of the vacuum package. However, the housing can also be produced from non-transparent material. For example, if the housing is not (entirely) made of material that can be penetrated by the sensor system from the outside, then the housing can also have one or more transparent sections that can be penetrated by the sensor system in order to record one or more vacuum packages disposed in the interior. For example, the housing can comprise windows that are transparent to an optical sensor so that, for example, an optical sensor arranged outside the housing can (at least in part) record the vacuum packages in the interior of the housing through the window or windows. In this case, the sensor system (or at least parts thereof) can be provided outside the housing. Arranging the sensors separately from the housing can be useful, for example, in order to be able to better clean the testing station. It can be possible to cover the sensor system (or the sensitive parts thereof) using simple devices when cleaning and thus prevent damage to the sensor system. Furthermore, the separate arrangement of the sensors outside the housing can make it possible to reduce soiling of the sensors during operation.

In the event that the sensor system works using microwaves and/or on the basis of the Doppler effect, then transparency of the housing (or parts thereof) may not be necessary. In this case, however, it must be ensured that the housing is made of material that is permeable to microwaves, where the degree of permeability to microwaves must certainly be selected such that the sensor system can detect a change in a dimension of the vacuum package to be tested. The change in shape of the film can be detected using an optoelectronic sensor system, for example, a light curtain or the like, or by way of electronic image processing. When using a sensor system based on the transmitter-receiver principle, such as a light curtain, the sensor system can be arranged to be transverse to the conveying direction of the vacuum packages. For this purpose, transmitters and receivers can be provided on both sides of the conveying system. The sensor system can detect a change in the vertical dimension, i.e. presently the height, of the vacuum package(s) to be tested. Alternatively or additionally however, it is also possible to determine and evaluate the horizontal dimension, i.e. presently the width, of the vacuum package(s) to be tested.

A sensor system that is mechanical (at least in part), for example, by way of scanning the vacuum package(s), can also be used. A scanning system, equipped with a simple sensor unit such as a proximity switch, can also be implemented. Scanning the vacuum package could be realized, for example, with guided probe plungers with a switching lug for contacting proximity switches (switching output: digital or analog).

According to a further exemplary embodiment of the testing station according to the invention, it comprises a control unit which is configured to control the operation of the negative pressure generating device according to the respective working state. The operation of the testing station can run in an automated manner, in particular fully automated.

The control unit can be associated with the negative pressure generating device such that the control unit activates a compressor or a pump for applying the test pressure to the housing for assuming the first working state. Alternatively or additionally, the control unit can be associated with the negative pressure generating device such that, for assuming the initialization state, the control unit deactivates the negative pressure generating device, the compressor, or the pump in order to apply reference pressure in the housing. For example, a vacuum connection in the form of a hose nozzle with a flange attachment can be provided between the compressor or the pump. The vacuum connection can be positioned anywhere at the housing. The hose nozzle diameter can be adapted to the evacuation chamber volume. The negative pressure generating device, in particular its pump, can have a delivery rate of, for example, more than 500 m³/h, in particular more than 550 m³/h, 600 m³/h, 650 m³/h or more than 700 m³/h.

The negative pressure generating device can comprise a pneumatic and/or electromechanical drive for adjusting the testing state and the initialization state. For example, the drive can be coupled to the control unit. The control unit can control, for example, the operation of the drive in an open-loop manner, in particular in a closed-loop manner.

The housing can be mounted to be movable relative to the vacuum package, where the control unit is configured, for assuming the testing process, to move the housing towards the vacuum package in such a way that it surrounds the one or more vacuum packages, and, for assuming a third working state, hereinafter the passive state, to move it away from the vacuum package.

The housing can also be immovable relative to the vacuum package, for example, if the testing station is integrated into a vacuum package system, the evacuation chamber of which can be used for the vacuum package of the products as well as for the testing process for the tightness of the package.

Furthermore, the sensor system can comprise a sensor unit and an evaluation unit. The sensor unit records sensor data of the vacuum package(s) to be tested, which can then be evaluated by the evaluation unit in order to infer the tightness of the vacuum package(s). The sensor unit and/or the evaluation unit can be arranged outside the test room, in particular outside the housing. The sensor unit and/or the evaluation unit can alternatively be arranged within the test room, in particular within the housing.

The sensor unit can be configured to record first sensor data in the initialization state which represents the initial spatial dimension(s) of the one or more vacuum packages in the initialization state. The sensor unit can furthermore be configured to record second sensor data at least once during the testing process which represents the spatial dimension(s) of the one or more vacuum packages during the testing process. Furthermore, the evaluation unit can be configured to detect a leak in at least one of the one or more vacuum packages based on a comparison of the first sensor data to the second sensor data. For example, a limit value or threshold value for a permissible change in the spatial dimension can be stored in the evaluation unit, and the evaluation unit can be configured to determine as a function of a comparison of the change in the spatial dimension to the limit value whether a leak is present.

The evaluation unit can also be configured to output a control signal indicating the detection of a leak in at least one of the one or more vacuum packages if a leak is detected in at least one of the one or more vacuum packages. Depending on how the sensor system is designed, the sensor system can detect which of the vacuum packages is/are leaking. Alternatively, the sensor system can also be able to detect only that one or more of the vacuum packages being tested simultaneously is/are leaking, without being able to distinguish which of the vacuum packages this is. Furthermore, the evaluation unit can be configured to output a control signal that identifies one, in particular each, leaky package among the several vacuum packages if a leak is detected in at least one of the one or more vacuum packages.

The control signal can be used to initiate corrective measures when at least one leaking vacuum package has been detected. A conceivable corrective measure is, for example, to discharge the leaky vacuum package of the several vacuum packages. In this case, the control signal can be used to control a track switch in the production system such that all or some of the leaky vacuum package(s) tested are discharged. The control signal can also be an alarm signal, in particular a visual display or an acoustic signal, which indicates a leaky package. In this case, staff could manually initiate corrective action in response to the alarm signal.

The several vacuum packages can each be associated with a test position or a test region in the recording field of the sensor system and the control signal can identify for each leaky package the corresponding test position or the corresponding test region of the leaky package.

According to a further exemplary embodiment and as already mentioned, the sensor unit of the sensor system comprises one or more optical sensor(s), one or more optoelectronic sensor(s), one or more electronic image recording unit(s), one or more mechanical sensor(s), and/or one or more sensor(s) operating according to the Doppler principle, which is/are configured to record the first and the second sensor data. The sensor unit can also consist of a combination of the different types of sensors mentioned. In an exemplary embodiment, the sensor system can comprise one or more image recording units, where the sensor system further comprises one or more projection devices that projects an optical pattern, in particular a raster, onto the one or more vacuum packages to be tested.

In an exemplary embodiment, the sensor system comprises one or more optical sensor(s). Each optical sensor can, for example, emit several light beams arranged in a line (beam line) and detectors corresponding to the light beams can detect the presence or interruption of the individual light beams. The optical sensor thus forms a light curtain composed of several parallel light beams that are directed at a respective detector and functionally corresponds to several light barriers arranged in parallel that are evaluated together. The one or more optical sensor(s) can be disposed transverse to the conveying direction of the vacuum packages and parallel to the normal of the plane of the support on which the vacuum packages are disposed. For this purpose, the components of the one or more optical sensors can be provided on both sides of the conveying system in order to detect a change in the vertical dimension, i.e. presently the height of the vacuum package(s) to be tested and/or in the horizontal dimension, i.e. presently the width of the vacuum package(s) to be tested.

The individual elements of the sensor that emit light beams can there generate a (one-dimensional) beam line with several light beams arranged at a predetermined distance, which act upon the one or more vacuum packages. Light detectors associated with the individual light beams can detect an interruption of the individual light beams. Due to the change in the number of interrupted light beams between the initialization state and during the testing process, the sensor system can detect a change in the dimension of the vacuum package(s). If, for example, vacuum packages are to be tested individually for leaks or several vacuum packages arranged in parallel in the beam direction simultaneously, the testing station can comprise, for example, a sensor with a light curtain and detectors that record the individual or several vacuum packages in the initialization state and during the testing process. If the beam line of the sensor is arranged vertically to the plane on which the vacuum packages are disposed, the sensor can then record a change in the height of the vacuum package(s) (when applying the test pressure in comparison to the reference pressure).

If several vacuum packages are to be tested for leaks simultaneously, individually, or in subgroups, then several optical sensors which record the individual vacuum packages or subgroups individually can be provided and detect a change in the dimension of the vacuum package or subgroups, respectively.

The sensor system can comprise at least one image recording unit. The image recording unit can basically be aligned almost arbitrarily relative to the vacuum packages to be recorded, as long as changes in the spatial dimensions of the vacuum packages to be tested can be detected reliably. For example, an image recording unit can be aligned to be transverse to the conveying direction of the vacuum packages, so that the normal of the image plane is aligned to be transverse to the normal of the support plane (e.g. formed by the conveyor belt). It is also possible for the normal of the image plane to be aligned in parallel with the normal of the support plane. If several image recording units are used, the vacuum packages can be recorded from different directions. Each image recording unit can be configured to record and to supply to the evaluation unit at least one image of the one or more vacuum packages in the initialization state and at least one image of the one or more vacuum packages during the testing process. Furthermore, the evaluation unit can be configured to detect a leak in at least one of the one or more vacuum packages based on a comparison of the images recorded in the initialization state and during the testing process.

It is possible for the sensor system to comprise one or more optical projectors, which together generate a light pattern, e.g. a light grid, or one light pattern each, e.g. a light grid. Each of the projectors can be configured to generate a light pattern or light grid with a predetermined raster and to act upon at least one of several vacuum packages with the light pattern or light grid. Each optical sensor can be associated with a test position or a test region.

In an exemplary development, the one or more image recording units records a light pattern or light grid with a predetermined raster acting upon the one or more vacuum packages. The evaluation unit can infer the tightness of the one or more vacuum packages based on a change in the pattern or raster of the light grid in the images in the initialization state and during the testing process. The test for tightness in a test region can be based on a comparison of the image data of the images in the initialization state and during the testing process in the test region. The differences in the image data can be determined, for example, using a difference image between corresponding image data in the initialization state and during the testing process. In an exemplary implementation, the evaluation unit can infer that at least one vacuum package is leaking if the entropy of the image data in the difference image is greater than a corresponding threshold value, which indicates a leaking vacuum package.

In an exemplary embodiment, the evaluation unit is configured to subject the image data of the images in the initialization state and during the testing process to filtering and/or image processing which enhances the differences between the images recorded in the initialization state and during the testing process. This can also include the formation of difference images from corresponding image data in the initialization state and during the testing process.

The evaluation unit can subdivide the recorded images from the camera into test regions, where each test region is associated with a package or a group of packages. Furthermore, the evaluation unit can be configured to test for each test region the at least one package in the test region for tightness. For this purpose, for example, difference images for the individual test regions can be formed from the corresponding image data in the initialization state and during the testing process for the respective test reports.

According to a further exemplary development, the evaluation unit is configured to identify the vacuum packages in at least one of the images in the initialization state and/or during the testing process and to define the test regions based on the vacuum packages identified.

The testing station can be configured to test several vacuum packages simultaneously. This means that the testing station is configured to subject several vacuum packages to the test pressure in one testing process. It can be provided that the several vacuum packages are arranged simultaneously within the housing defining the evacuation chamber, where the evacuation chamber is evacuated and all of the several vacuum packages are detected by way of the sensor system for determining a change in the respective spatial dimensions.

The sensor system of the testing station can also be able to individually record different test positions or test regions, each of which is associated with at least one of the vacuum packages. Furthermore, the evaluation unit can be configured to individually test the tightness of the at least one vacuum package at each test position or in each test region based on the sensor data from the sensor system. In this respect, several vacuum packages can be tested for tightness simultaneously in a single testing process and it is possible, if present, to identify the vacuum package or those vacuum packages of the several vacuum packages tested that are leaking. It is therefore not necessary to declare all of the several vacuum packages that were tested in the one testing process to be discard, but rather the one or more leaking vacuum packages can be selectively differentiated from the others.

In a further exemplary embodiment, the testing station further comprises a counter negative pressure generating device which is associated with the support and is configured to apply a counter negative pressure to an underside of the support facing away from the test room. The counter negative pressure applied by the counter negative pressure generating device can be greater in magnitude than the test pressure. The counter negative pressure can be used to prevent the flexible support, such as the conveyor belt, from bulging up and deforming when the test pressure is applied, which can impair tightness testing.

According to an exemplary further development, the control unit is furthermore configured to activate the counter negative pressure generating device temporally prior to the negative pressure generating device. For example, the counter negative pressure can build up prior to the test pressure so that it is ensured that a counter negative pressure is present during the entire tightness testing, i.e. during the entire time in which the test pressure prevails. The control unit can control the operation of the counter negative pressure generating device and of the negative pressure generating device such that the counter negative pressure is fully applied before the test pressure is applied.

According to another exemplary further development, the counter negative pressure generating device comprises a plurality of separate evacuation chambers, in particular formed to be identical. The evacuation chambers can be oriented to be transverse to and/or in the direction of the longitudinal direction of the support and/or in particular be distributed evenly. Furthermore, at least one reinforcement strip can be provided and be configured such that the supports can rest flat thereon.

According to a further aspect of the present invention, which can be combined with the preceding aspects and exemplary embodiments, a method is provided for testing for the tightness of one or more vacuum packages, each of which has an initial spatial dimension at a reference pressure. The method according to the invention comprises the following steps of: subjecting the one or more vacuum packages to a test pressure that is reduced in comparison to a reference pressure; recording a change in the spatial dimension of at least one of the one or more vacuum packages during the application of the test pressure relative to the respective initial spatial dimension of the one or more vacuum package; and determining whether at least one of the one or more vacuum packages is leaking based on the change in the spatial dimension recorded. A change in the spatial dimension can be detected either in one spatial axis, in two spatial axes, or in all three spatial axes, where a change in the spatial dimension in one of the three spatial axes can indicate a leaking vacuum package.

In an exemplary development of the method according to the invention, recording a change in the spatial dimension of at least one of the one or more vacuum packages during the application of the test pressure relative to the respective initial spatial dimension of the one or more vacuum packages comprises the following method steps of: recording first sensor data of a sensor system which represents the initial spatial dimension of the one or more vacuum packages in an initialization state when the reference pressure is applied; recording second sensor data of a sensor system, which represents the spatial dimension of the one or more vacuum packages during a testing process that temporally follows the initialization state, where the reference pressure is lowered to the test pressure during the testing process; and recording a change in the spatial dimension of at least one of the one or more vacuum packages by comparing the first sensor data and second sensor data recorded. Optionally, second sensor data can be recorded multiple times (e.g. at time intervals) or continuously during the testing process and compared with the first sensor data in order to detect a change in the spatial dimension of at least one of the one or more vacuum packages.

In a further exemplary embodiment, it is determined in the method according to the invention whether at least one of the one or more vacuum packages is leaking when the comparison of the sensor data indicates that the magnitude of change in the spatial extension exceeds a limit or threshold value. The limit value or threshold value can, for example, be set in advance, queried, or derived from a database with empirical values on vacuum package-specific limit values or threshold values, and/or specified by user input.

In an exemplary further development, the method according to the invention furthermore comprises that, if a leak is detected in at least one of the one or more vacuum packages, a control signal is output indicating the detection of a leak in at least one of the one or more vacuum packages.

In another exemplary further development, the method according to the invention furthermore comprises that, if a leak is detected in at least one of the one or more vacuum packages, a control signal is output identifying each leaky package among the several vacuum packages.

In the method, several vacuum packages can each be associated with a test position or a test region in the recording field of the sensor system and the control signal can identify for each leaky package the corresponding test position or the corresponding test region of the leaky package.

According to a further exemplary development of the method according to the invention, the method comprises the following method steps of: acting upon the one or more vacuum packages with a light curtain made of several light beams arranged at a predetermined distance create with a predetermined raster in an initialization state when the reference pressure is applied; and acting upon the one or more vacuum packages with the light curtain during the testing process when the test pressure is applied; and detecting a change in the dimension of at least one of the one or more vacuum packages based on a change in the number of interrupted light beams in the initialization state and during the testing process.

According to a further exemplary development of the method according to the invention, the method comprises the following method steps of: recording at least one image of the one or more vacuum packages in the initialization state and during the testing process, and detecting a leak in at least one of the one or more vacuum packages based on a comparison of the images recorded in the initialization state and during the testing process.

In an exemplary further development, the method according to the invention further comprises that the one or more vacuum packages is/are acted upon with a light pattern or a light grid with a predetermined raster in an initialization state when the reference pressure is applied and during the testing process when the test pressure is applied.

Furthermore, the recorded images can record a light grid with a predetermined raster acting upon the one or more vacuum packages and can infer the tightness of the one or more vacuum packages based on a change of the raster of the light grid in the images in the initialization state and during the testing process.

Furthermore, according to the method according to the invention, image data of the images in the initialization state and during the testing process can be subjected to filtering and/or image processing in order to enhance the differences between the images recorded in the initialization state and during the testing process (e.g. by an edge filter or by the creation of difference images).

Furthermore, the images recorded by a camera or other image recording unit can be subdivided into test regions, where each test region can be associated with at least one package and, for each test region, the at least one package in the test region can be tested for leaks. The test for tightness in a test region can be based on a comparison of the image data of the images in the initialization state and during the testing process in the test region.

According to a further exemplary development of the method according to the invention, the method comprises the following method steps of: identifying the vacuum packages in at least one of the images in the initialization state and/or during the testing process; and defining test regions or test positions based on the vacuum packages identified.

According to a further aspect of the present invention, which is combinable with the foregoing aspects and exemplary embodiments, a computer-readable medium is provided that stores instructions which, when executed by a processing unit (e.g., a processor unit), cause the processing unit to carry out a method according to one of the aspects or exemplary embodiments of the testing method according to the invention previously described. Should a method step require a unit or a component outside the processing unit, then the processing unit is configured to cause this unit or component to carry out the respective method step.

According to a further aspect of the present invention, which is combinable with the foregoing aspects and exemplary embodiments, a testing station is provided which comprises devices which are configured to carry out the method according to one of the aspects or exemplary embodiments of the testing method according to the invention previously described.

According to a further aspect of the present invention, which is combinable with the foregoing aspects and exemplary embodiments, a vacuum packaging station is provided which comprises a testing station according to one of the aspects or exemplary embodiments previously described.

According to an exemplary further development, the vacuum packaging station according to the invention further comprises devices for producing the one or more vacuum packages, in particular those vacuum packages which are subsequently tested for tightness using a testing station according to the invention and/or using a testing method according to the invention.

It is to be noted that the method according to the invention can be defined so as to implement the testing station according to the aspects of the invention described, and vice versa.

### BRIEF DESCRIPTION OF THE FIGURES

Further properties, features, and advantages of the invention shall become clear hereafter by describing preferred embodiments of the invention with reference to the accompanying exemplary drawings, in which:

FIG. 1 shows a schematic diagram of a testing station according to an exemplary embodiment of the present invention;

FIG. 2 shows a schematic diagram of a section of a production line for producing a vacuum package with integrated tightness testing according to the present invention;

FIG. 3 shows a front view of an exemplary embodiment of a testing station according to the invention;

FIG. 4 shows a side view of the testing station from FIG. 3;

FIG. 5 shows a top view of the testing station from FIGS. 3 and 4;

FIGS. 6-11 shows schematic diagrams of the process of tightness testing using the testing station according to FIGS. 3 to 5 according to a first exemplary embodiment;

FIGS. 12-21 show schematic diagrams of the process of tightness testing using a further exemplary embodiment of a testing station of the invention according to a further exemplary embodiment;

FIG. 22 shows a flow chart of an exemplary embodiment of a testing method according to the invention; and

FIG. 23 shows a detailed section of the flow diagram from FIG. 22 according to an exemplary further development of the testing method according to the invention;

FIG. 24 shows a top view onto a testing station according to another exemplary embodiment of the present invention;

FIG. 25 shows a side view in sectional illustration of the testing station according to FIG. 24 along the line X-X; and

FIG. 26 shows a perspective view of a counter negative pressure generating device of the testing station from FIGS. 24 and 25.

### DETAILED DESCRIPTION

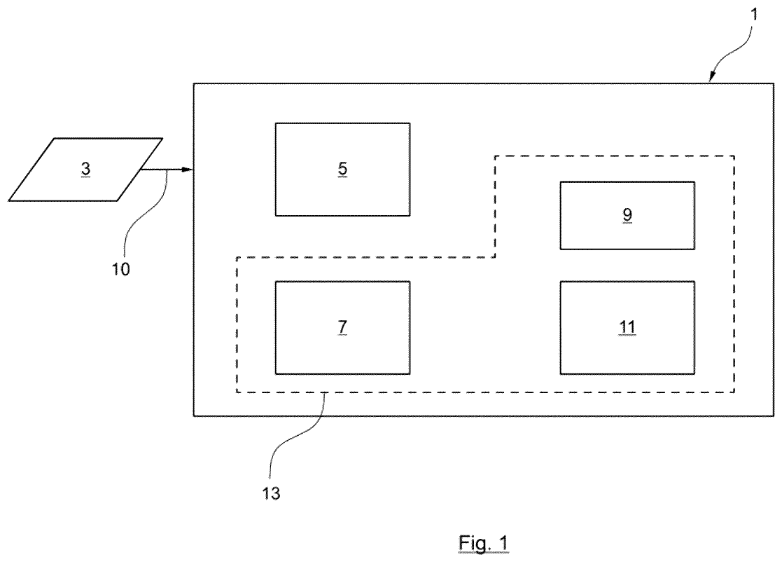

FIG. 1 shows a schematic diagram of a testing station according to the invention, which is generally provided with reference character 1, for testing for the tightness of one or more vacuum packages, which are provided with reference character 3. In the following description of the exemplary embodiments based on the accompanying figures, one vacuum package 3 shall be referred to in general for the sake of simplicity, where several vacuum packages 3 can be tested in an analogous manner using testing station 1 according to the invention or the testing method according to the invention.

Testing station 1 from FIG. 1 comprises the following main components: a negative pressure generating device 5, which is configured to subject vacuum package 3 (or several thereof) to be tested and supplied to testing station 1 (arrow with reference character 10) from the outside to a test pressure that is reduced in comparison to a reference pressure which can be, for example, atmospheric pressure; and a sensor system 7 which is configured to determine sensor data in relation to vacuum package(s) 3 and to determine based on the sensor data whether tested vacuum package(s) 3 is/are leaking.

Vacuum packages 3 are generally gas-tight and/or fluid-tight vacuum packages for objects that are tightly surrounded by the vacuum package when disposed within the latter. Vacuum packages can be, for example, plastic and aluminum composite films in the form of a deep-drawn film, tubular bags, flat bags, sealed edge bags, or hard shells with a top film. In such vacuum packages, an internal pressure generally prevails that is lower than atmospheric pressure under normal conditions. In the food industry, for example, a rough vacuum prevails with a pressure difference between internal pressure and atmospheric pressure of no less than 0.06 MPa. Depending on the item to be packaged, it is clear that a different vacuum quality, such as a fine vacuum, can also be set.

Vacuum packages 3 to be tested have an initial spatial dimension at a reference pressure (e.g. atmospheric pressure). The spatial dimension is to be understood to be the size or volume of vacuum package 3 in relation to two of the three spatial axes or alternatively also in relation to all three spatial axes. The initial spatial dimension is the spatial dimension at reference pressure (e.g. atmospheric pressure). The spatial dimension is recorded, for example, by way of sensor system 7. The initial spatial dimension is determined by sensor system 7 when the reference pressure (e.g. atmospheric pressure) is applied.

Alternatively, the initial spatial dimension can be taken from a database with empirical values for specific vacuum packages 3 or can also be transferred to testing station 1 by way of user input 100. If the spatial dimension of the vacuum packages of the products are (substantially) constant, a corresponding initialization value can also be stored in a memory of testing station 1 and be read out. It is also possible for the testing station to continuously or periodically adjust the initial spatial dimension using machine learning based on the sensor data of the vacuum packages being tested. In these alternative examples, the recording of the initial spatial dimension of the one or more vacuum packages 3 to be tested can be omitted when the reference pressure is applied.

According to one aspect of the present invention, sensor system 7 is configured to determine, based on a change in the spatial dimension of vacuum package(s) 3 during the application of the test pressure relative to the initial spatial dimension of vacuum package(s) 3, whether a tested vacuum package 3 is leaking. The invention takes advantage of the fact that, when a leaky vacuum package 3 is subjected from the outside to a test pressure that is reduced in comparison to a reference pressure, the spatial dimension of leaky vacuum package 3 changes. If there is a leak in vacuum package 3, the latter will inflate significantly within a short time. The inflation of vacuum package 3 can be detected by way of sensor system 7 and used for determining whether vacuum package 3 is leaking.

In principle, several vacuum packages 3 can also be tested simultaneously in one testing process. Depending on the configuration of the sensor system, the initial spatial dimension in such a case can relate simultaneously to all vacuum packages 3 to be tested, to individual initial spatial dimensions of vacuum packages 3 to be tested (e.g. at different test positions or in different test regions), or to individual initial spatial dimensions of subgroups of vacuum packages 3 to be tested (e.g. at different test positions or in different test regions). Where testing a vacuum package 3 is mentioned in the singular form hereafter, this of course also means testing several vacuum packages 3 simultaneously or in subgroups.

Vacuum package 3 can be tested, for example, in that sensor system 7 in a so-called initialization state records first sensor data which represents the initial spatial dimension of vacuum package 3 (or several vacuum packages 3) in the initialization state. However, this step can also be omitted if the initial spatial dimension of vacuum package 3 (or several vacuum packages 3) is available elsewhere, as already explained. In a so-called testing process, in which the pressure to which vacuum package 3 is subjected is lowered from the reference pressure prevailing in the initial state to the test pressure by use of negative pressure generating device 5, second sensor data is recorded by way of sensor system 7 which represents the spatial dimension of vacuum package 3 (or several vacuum packages 3) during the testing process. The recorded second sensor data can there be recorded multiple times (e.g. at predetermined time intervals) or continuously by sensor system 7 during the testing process, i.e. while the reference pressure is lowered to the test pressure.

As a result of the application of the test pressure, i.e. the lowering of the pressure from the reference pressure to the test pressure, a tested vacuum package 3 changes its spatial dimension if it is leaking. The change in the spatial dimension manifests itself in particular in such a way that tested vacuum package 3 inflates while the pressure is lowered from the reference pressure to the test pressure. The inflation of vacuum package 3 can be recorded by way of sensors system 7. A leak in vacuum package 3 can be detected by an evaluation unit 9 based on a comparison of the first sensor data recorded in the initialization state and (one of the several sets of) second sensor data recorded during the testing process.

Alternatively, it would also be conceivable to compare second sensor data recorded at different times during the testing process with one another. In this case, evaluation unit 9 could detect the inflation of vacuum package 3 and thus a leak in vacuum package 3 based on a comparison of the (multiple sets of) second sensor data recorded during the testing process.

In order to be able to detect a change in the spatial dimension of vacuum package 3 that can be recorded by sensor system 7, a sufficiently high volume flow in relation to the volume of the test room when the test room is evacuated, in comparison to the possible volume flow from the interior of the leaky vacuum package during the testing process, is relevant. This evacuation volume flow of the test room should be sufficiently higher than the volume flow from the interior of the defective vacuum package so that the leaky vacuum package inflates while reference pressure p_{R} is lowered to test pressure p_{P}. Accordingly, the lowering of reference pressure p_{R} to test pressure p_{P} (i.e. the evacuation of the test room) should advantageously take place relatively quickly, for example, within a few or less than a second, for example, within 0.5 s to 1.0 s, in order to ensure a respective difference in the volume flows. This also means that negative pressure Δp=p_{R}−p_{P} to be generated in the test room generally does not need to be particularly high (for example, in the range of (light) rough vacuum), which in turn is advantageous as it prevents damage to tight vacuum packages by applying a negative pressure that is too high with regard to the internal pressure of the vacuum packages. As mentioned, the latter is in the range of 0.06 MPa in the food industry.

In an exemplary embodiment, a rough vacuum is generated in the test room in the testing state within a predetermined evacuation time of the test room. A rough vacuum is presently understood to mean an absolute pressure in the range between reference pressure p_{R}(e.g. standard atmosphere or atmospheric pressure at sea level (p_{R}=0,101325 MPa)) and a test pressure p_{P} that is reduced by up to 0.09 MPa in comparison to the reference pressure (i.e. (i.e. p_{R}−0.09 MPa≤p_{P}<p_{R}). The reference pressure can correspond, for example, to atmospheric pressure p_{R} at the respective sea level at the location where testing station 1 is used. In principle, however, it is also possible or conceivable to generate even higher negative pressure in the test room during the testing process, reaching the fine vacuum (p_{P}≤p_{R}−0.09 MPa, e.g. p_{P}≤0,011325 MPa at p_{R}=0,101325 MPa).

In an advantageous embodiment, the difference Op between reference pressure p_{R} and test pressure can be in the range of 0.03 MPa to 0.08 MPa (i.e. Δp=p_{R}−p_{P}∈[0.03 MPa; 0.08 MPa]). Further exemplary ranges for the difference Δp between reference pressure p_{R} and test pressure are:
0.03 MPa to 0.12 MPa (i.e. Δp∈[0.03 MPa; 0.12 MPa]).
0.03 MPa to 0.1 MPa (i.e. Δp∈[0.03 MPa; 0.10 MPa]).
0.03 MPa to 0.08 MPa (i.e. Δp∈[0.03 MPa; 0.08 MPa]).
0.03 MPa to 0.06 MPa (i.e. Δp∈[0.03 MPa; 0.06 MPa]).
0.01 MPa to 0.08 MPa (i.e. Δp∈[0.01 MPa; 0.08 MPa]).
0.01 MPa to 0.06 MPa (i.e. Δp∈[0.01 MPa; 0.06 MPa]).
0.01 MPa to 0.04 MPa (i.e. Δp∈[0.01 MPa; 0.04 MPa]).

As mentioned, pressure difference Op to be set should be selected just high enough so that the spatial dimension of a leaky vacuum package 3 changes noticeably for sensor system 7 in a testing process (i.e. within the evacuation time). Pressure difference Op can also depend on the material of the package (e.g. film) so that pressure difference Op to be set can be selected based on the material of the vacuum package. For example, packages with thicker films may require higher test pressure than thinner films or resealable vacuum packages. Furthermore, it can be taken into account that pressure difference Op is not so large (i.e. in the region of the rough vacuum or in the lower region of the fine vacuum) that a tight vacuum package 3 is damaged by the application of the test pressure and then becomes leaky (e.g. also with resealable vacuum packages). Furthermore, it may be important to consider how the test room is formed in the respective implementation of testing station 1. For example, the test room can be defined in part by a flexible support surface (e.g. a conveyor belt) so that, for example, difference Op to be set should not be so large so that it does not deform the support surface in such a way that the measurement of sensor system 7 is influenced and incorrect results are obtained during tightness testing.

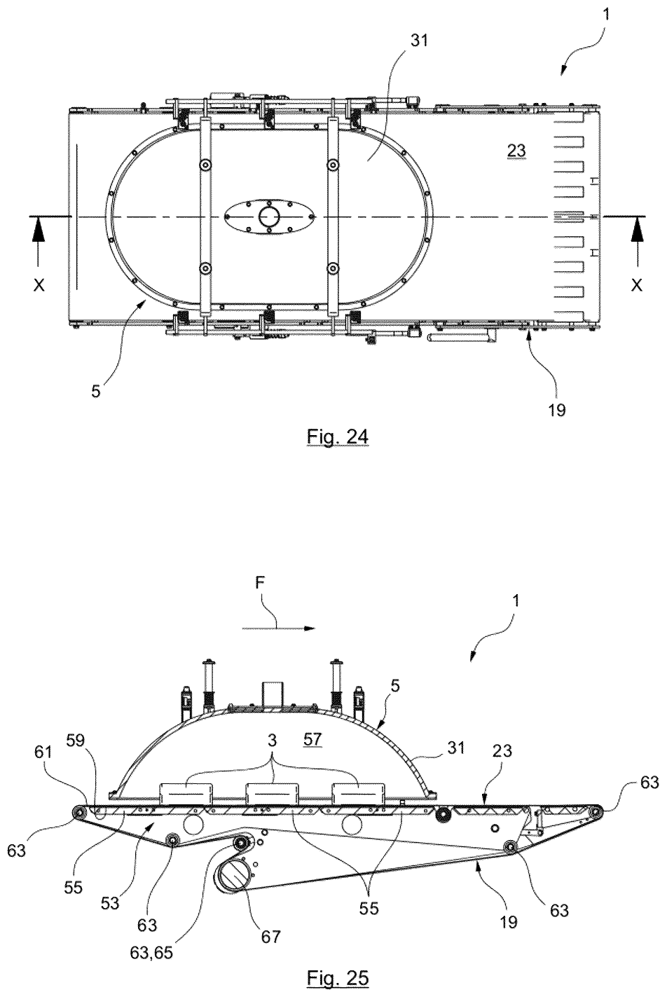

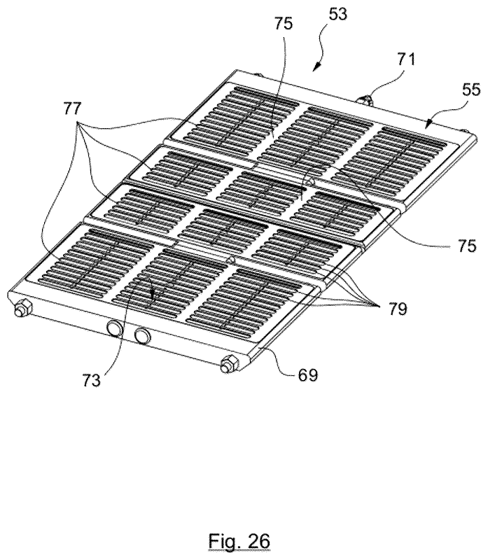

In particular in the event that the support is a flexible, bendable conveyor belt 23, it has proven to be advantageous to have testing station 1 comprise a counter negative pressure generating device 53, as illustrated acc. to FIGS. 24-26. FIG. 24 represents a top view to the sectional view from FIG. 25 which is formed along the line X-X from FIG. 24. Counter negative pressure generating device 53 basically serves to apply a counter negative pressure to an underside 59 of conveyor belt 23 facing away from test room 57 or vacuum packages 3, which can be greater in magnitude than the test pressure to be applied in test room 57. By way of counter negative pressure generating device 53, a bulging or excessive deformation of conveyor belt 23 is prevented when the test pressure is applied by way of negative pressure generating device 5. Counter negative pressure generating device 53 ensures that conveyor belt 23 remains substantially non-deformed and in particular flat, as indicated in FIG. 25. In this way, tightness testing is ensured as reliably as possible.

Conveying system 19 according to the exemplary embodiment in FIG. 25 comprises flexible, bendable conveyor belt 23 which is configured to be flat on its upper side 61 disposed opposite underside 59 in order to create a flat support for vacuum packages 3 and a flat support for housing 31 of negative pressure generating device 5 so that a tight test room 57 can be reliably formed. The conveyor belt is led over several deflection rollers 63, at least one of which is combined by way of a tensioning device 65 in order to pre-tension the conveyor belt as desired. Conveyor belt 23 is driven by a motor, presently a drum motor 67.

A synopsis of FIGS. 25 and 26 clarifies the structure of an exemplary embodiment of counter negative pressure generating device 53. As can be seen in FIG. 25, counter negative pressure generating device 53 comprises three vacuum panels 55 arranged one behind the other in conveying direction F which can each be formed to be identical. For example, all of vacuum panels 55 are connected to the same negative pressure source, such as a vacuum pump. Alternatively, each of vacuum panels 55 can also be associated with a separate negative pressure source.

FIG. 26 shows a perspective view of an exemplary embodiment of such a vacuum panel 55 which as a base has a plate-like structure 69 which comprises a port 71 for connecting to a negative pressure source, not shown. Upper side 73 of vacuum panel 55 facing underside 59 of conveyor belt 23 is formed, on the one hand, by a plurality of upwardly open evacuation chambers, indicated by reference character 79m, which are separated from one another and are each acted upon with the counter negative pressure, as well as, on the other hand, by reinforcement strips 75 which enable conveyor belt 23 to rest flat on vacuum panels 55. The plurality of evacuation chambers 79 can be formed, for example, by sheet metal inserts 77 which are placed onto plate structure 69. The provision of a plurality of separate evacuation chambers 79 that are separated from one another has proven to be advantageous in that the performance of the negative pressure source can be reduced so that the system can be implemented inexpensively.

In order to ensure a sufficient volume flow for evacuating the test room within the evacuation time, negative pressure generating device 5 can have a delivery rate, for example, of more than 500 m³/h, in particular more than 550 m³/h, 600 m³/h, 650 m³/h or more than 700 m³/h. In one embodiment of the invention, negative pressure generating device 5 enables a volume flow of 720 m³/h (=0.2 m³/s). In principle, the necessary volume flow of negative pressure generating device 5 can be determined based on desired negative pressure Δp, the volume of the test room, and the desired evacuation time.

Evaluation unit 9 can be, for example, a computing unit which can in particular be configured as a processor or as a system-on-chip (SoC). Evaluation unit 9 can also be referred to as a processing unit. Evaluation unit 9 can also comprise a volatile (e.g. DRAM) and/or a non-volatile memory (e.g. flash memory, SSD, etc.) in which the recorded measurement data of the sensor unit of sensor system 7 is stored temporarily for evaluation and/or the initial spatial dimension of vacuum packages 3 to be tested can be stored. The computing unit can be a normal CPU, but can also be implemented as a digital signal processor (DSP), as a programmable logic device (DSP), field programmable gate array (FPGA) or application specific integrated circuit (ASIC). Evaluation unit 9 can execute commands to cause testing station 1 to carry out the various embodiments of a testing method for tightness described herein. The commands can be stored in a memory of evaluation unit 9 or another memory (e.g. non-volatile memory (e.g. flash memory, SSD, etc.) which evaluation unit 9 can access.

Evaluation unit 9 can also generate a control signal that indicates when a leaky vacuum package 3 has been detected. The control signal can alternatively or additionally be an acoustic or visual alarm signal that is output, for example, to cause the leaky vacuum package 3 to be sorted out manually.

Testing station 1 can furthermore comprise a control unit 11 which is configured to control the operation of negative pressure generating device 5 and/or sensor system 7 according to the respective working state, i.e. the initialization state or the testing process. An electronic component 13 is illustrated in a representative manner by a dashed line with reference character 13 in FIG. 1 which in particular combines structurally and/or locally the entire electronics of testing station 1.

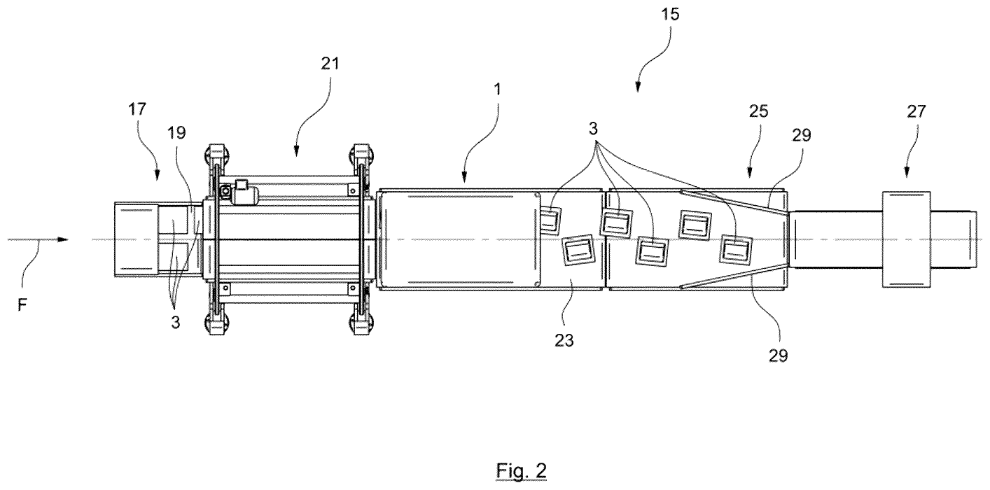

FIG. 2 shows an exemplary embodiment of a production or conveyor line 15 into which a testing station 1 according to the invention is integrated. In conveying direction F, a vacuum package production device 17, such as a deep-drawing device, is arranged at the start and transfers the finished vacuum packages 3 to a conveyor device 19, such as a conveyor belt. It is assumed in this exemplary embodiment that testing station 1 forms its own station in production line 15. In principle, however, it is also possible to integrate testing station 1 into vacuum package production device 17. In this case, the test room of testing station 1 can be identical to the chamber in which the products are vacuum packaged in vacuum package production device.

An optional preparation station 21 can follow vacuum package production device 17. In preparation station 21, vacuum packages 3 to be tested can be prepared for efficient and effective operation of testing station 1 which follows in conveying direction F. For example, a desired, predetermined position of arriving vacuum packages 3 to be tested can be set by way of preparation station 21.

In downstream testing station 1, the testing method according to the invention for testing for tightness of vacuum packages 3 takes place. With regard to the mode of operation of testing station 1 and the sequence of the testing method according to the invention, reference is made to the previous and following descriptions.

Downstream of testing station 1, tested vacuum packages 3 are arranged offset from one another in conveying direction F and transversely thereto. Tested vacuum packages 3 can again be conveyed via a conveying system, such as a conveyor belt 23. Arranged downstream of testing station 1 can be a lock 25 which is configured to discharge vacuum packages 3 that have been detected as being leaky from production line 15 in response to a control signal generated by sensor system 7 or by testing station 1, respectively. It is ensured in this way that only vacuum packages 3 that have been detected as being tight are transferred to downstream treatment station 27. The targeted and centered transfer of tested vacuum packages 3 into the treatment station 27 takes place, for example, via funnel-like tapered baffle plates which are indicated by reference character 29.

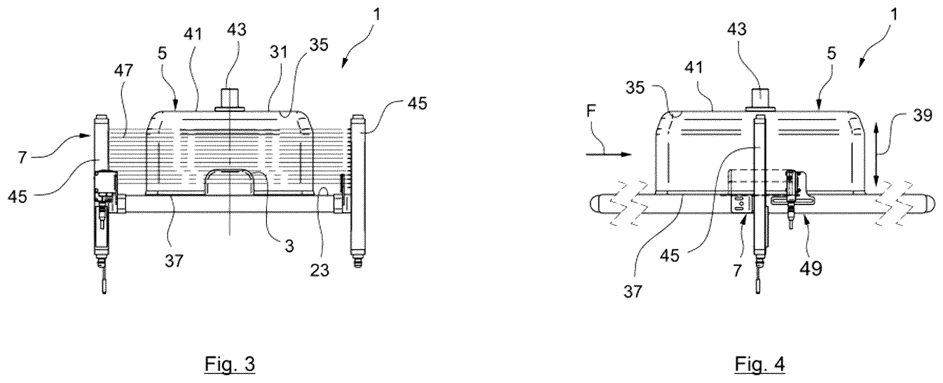

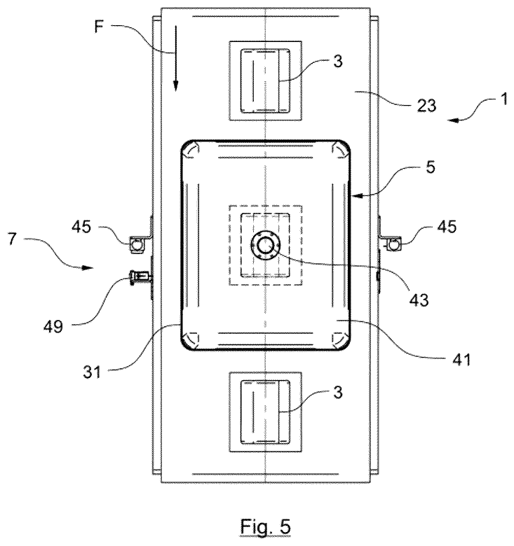

FIGS. 3-5 depict a first exemplary embodiment of a testing station 1 according to the invention in a front view (FIG. 3), side view (FIG. 4), and top view (FIG. 5). It is assumed in this exemplary embodiment as well, purely by way of example, that testing station 1 forms its own station in production line 15. In correspondence to production line 15 from FIG. 2, vacuum packages 3 to be tested are conveyed in conveying direction F by way of a conveyor belt 23 into testing station 1, therethrough, and away therefrom. According to the exemplary configuration of FIGS. 3-5, negative pressure generating device 5 is formed by a housing 31 which is transparent at least in sections, by way of example provided with a viewing window, and which defines an evacuation chamber 35 in its interior that forms the test room. Testing station 1 can comprise a pneumatic and/or electromechanical drive to raise and lower housing 31. For example, the drive can be coupled to control unit 11. Control unit 11 can control in an open-loop manner, in particular in a closed-loop manner, for example, the operation of the drive. In principle, housing 31 could also be immovable relative to vacuum package 3, for example, if testing station 1 is integrated into a vacuum package system, evacuation chamber 35 of which can be used both for the vacuum packaging of the products and for the testing process for the tightness of the package.

Housing 31 is preferably to be configured to be as light as possible and as stable as necessary. Possible materials include PC, acrylic, GRP, carbon or the like. Housing 31 has a hood-like or bell-like structure. Housing 31 can be formed to be substantially rectangular in cross section. On the bottom side, the test room and therefore evacuation chamber 35 are formed by conveyor belt 23 which forms the support for vacuum package 3.

In FIGS. 3-5, testing station 1 is in the testing process. This means that housing 31 is in gas-tight and/or fluid-tight contact with conveyor belt 23. To reinforce the seal between the underside of housing 31 and conveyor belt 23, the housing can comprise on a ring support surface 37 facing conveyor belt 23 a seal which can be, for example, a profile lip seal, a round cord seal, such as an O-ring, a silicone seal, or a flat seal.

As indicated in FIG. 4 by the double arrow with reference character 39, housing 31 can be moved perpendicular to the direction of extension of conveyor belt 23, in particular vertically up and down, for assuming the different working states of negative pressure generating device 5 according to FIGS. 3-5.

A port 43 is provided on an upper side 41 of housing 31 for a negative pressure source, not shown. Port 43 can be, for example, a vacuum port in the form of a hose nozzle. It should be clear that port 43 can be positioned anywhere on housing 31 as long as the operation of negative pressure generating device 5 and a sufficiently high volume flow through port 43 can be ensured. The test pressure, a reference pressure, or an initialization pressure, such as an atmospheric pressure, can be set in the test room via port 43 by way of the negative pressure source and associated components, in dependence of the working state of negative pressure generating device 5. Negative pressure generating device 5 can comprise, for example, a compressor or a pump (not shown in FIGS. 3-5) which is connected to port 43 for applying the test pressure in the interior of housing 31. The pump or compressor can have a delivery rate, for example, of more than 500 m³/h, in particular more than 550 m³/h, 600 m³/h, 650 m³/h or more than 700 m³/h for lowering the reference pressure to the test pressure during the testing process. Negative pressure generating device 5 can also comprise one or more valves (not shown in FIGS. 3-5) for producing the reference pressure in the interior of evacuation chamber 35. The compressor/pump or the valve, respectively, can be controlled by a control unit 11.

Sensor system 7 for recording sensor data of vacuum package 3, by way of which it can be determined whether tested vacuum package 3 is leaking, is arranged approximately centrally with respect to a longitudinal extension of housing 31 in the example shown. In the exemplary embodiment of FIGS. 3-5, the sensor system comprises an optical sensor unit 45 which is configured to generate a light curtain 47. As can be seen schematically in FIG. 3, light curtain 47 has several parallel light beams and extends to be transverse to conveying direction F, in particular over the entire width of conveyor belt 23. Light curtain 47 of sensor unit 45 is formed by corresponding light sources of sensor unit 45 on one side of conveyor belt 23 which are emitted transverse to conveying direction F and are directed towards light detectors of sensor unit 45 on the other side of conveyor belt 23. The light beams can there be aligned parallel to one another at a predetermined distance (viewed in conveying direction F). The light sources of sensor unit 45 can be arranged on a line or substantially in a line (e.g. slightly offset from one another). For example, the distance between the light beams (or the distance between the light sources) can be 1 mm to 10 mm, preferably 3 to 8 mm, and particularly preferably 5 mm. In principle, however, longer or shorter distances are also conceivable.

The light detectors of sensor unit 45 detect whether the associated light beam impinges the respective light detector or is interrupted by an object. The light detectors of sensor unit 45 each output a corresponding detection signal to evaluation unit 9 in the initialization state and during the testing process.

Vacuum package 3 to be tested is acted upon with light curtain 47 in order to generate sensor data in the initial state and during the testing process by way of the light detectors of sensor unit 45 which are supplied to evaluation unit 9 and used to verify whether the tested vacuum package 3 is leaking. The sensor data supplied to evaluation unit 9 represents the initial spatial dimension of vacuum package 3 to be tested in the initialization state (first sensor data) and the (possibly changed) spatial dimension of vacuum package 3 to be tested during the testing process (second sensor data). If the first and the second sensor data indicate a changed spatial dimension of vacuum package 3 to be tested, then vacuum package 3 is leaking. In the embodiment shown, the sensor data can indicate the number of interrupted or non-interrupted light beams in the initial state Nᵢₙᵢₜᵢₐₗ and during the testing process (N_{testing}). If the difference between these numbers (or their magnitude) exceeds a threshold value (|Nᵢₙᵢₜᵢₐₗ−N_{prüfung}|≥S or |Nᵢₙᵢₜᵢₐₗ−N_{testing}|>S), evaluation unit 9 detects a leaky vacuum package 3 and outputs a corresponding control signal. In one embodiment, the threshold value is S∈[1, 2, 3, 4, . . . ]. The control signal can control, for example, downstream lock 25 such that vacuum package 3 identified as being leaking is discharged from production line 15. Light sources of sensor unit 45 can there be arranged on a line or substantially in a line (e.g. slightly offset from one another). If the distance between light beams (or the distance between the light sources) of sensor unit 45 is, for example, 5 mm, a threshold value of S=2 and the condition |Nᵢₙᵢₜᵢₐₗ−N_{testing}|>S) would mean that the spatial dimension would have to change by at least 10 mm for evaluation unit 9 to detect a vacuum package 3 as being leaky. By selecting threshold value S, the “sensitivity” of evaluation unit 9 for detecting leaky vacuum packages 3 can be controlled, for example, to prevent incorrect detection of vacuum packages. For example, due to the negative pressure during the testing process, in the case of a tight vacuum package of meat, meat juice could collect at one point of the vacuum package and locally lead to a change in the spatial dimension of the vacuum package, which could then be incorrectly detected by evaluation unit 9 as being a leak. Since such potentially occurring changes in the spatial dimension of tight vacuum packages are smaller in practice in comparison to changes in the spatial dimension of vacuum packages that are in fact leaking, threshold value S can therefore serve to prevent false positives.

It is also possible for sensor unit 45 to comprise only one light detector onto which all light beams impinge (provided they are not interrupted). In this case, the light detector measures the light intensity (which correlates to the number of incident light rays) and the sensor signals output by sensor unit 45 represent the measured light intensity in the initial state and during the testing process. In this case, a change in the external dimension of vacuum package 3 can be detected by evaluation unit 9 based on a change (in particular, lowering) in the measured light intensity between the initial state and a measurement during the testing process.

Optical sensor unit 45 is associated with a downstream light barrier 49 or a similar optoelectronic system. In this example, vacuum packages 3 to be tested is positioned relative to sensor unit 45 by way of light barrier 49 or a similar optoelectronic system. The distance between light barrier 49 and sensor unit 45 is selected, for example, based on the size of vacuum package 3 in conveying direction F such that light curtain 47 of sensor unit 45 records (approximately) the center (in particular the center of gravity) of vacuum package 3 when the end of vacuum package 3 interrupts the light barrier 49 in conveying direction F. This can ensure that sensor system 7 (sensor unit 45) has a suitable position relative to vacuum package 3 to be tested in order to test for the tightness of vacuum package 3.

Light barrier 49 or a similar optoelectronic system is connected to control unit 11 so that control unit 11 can initiate a testing process in dependence of an output signal from light barrier 49 or a similar optoelectronic system. If light barrier 49 is interrupted by a vacuum package 3 on conveyor belt 23, control unit 11 can stop conveyor belt 23 and the test cycle begins.

In the exemplary embodiment shown, the test cycle comprises lowering housing 31 (establishing the initialization state at reference pressure), determining the initial spatial dimension of vacuum package 3 to be tested (recording the first sensor data in the initialization state), lowering the reference pressure to the test pressure in evacuation chamber 35 (testing process), determining once, multiple times, or continuously the spatial dimension of vacuum package 3 to be tested during the testing process (recording the second sensor data during the testing process once, multiple times, or continuously), evaluating the first and second sensor data and outputting a control signal by evaluation unit 9, as well as establishing the reference pressure in evacuation chamber 35 before or by raising housing 31. After such a test cycle, for example, in response to a control signal from evaluation unit 9, control unit 11 can start conveyor belt 23 again and position by way of light barrier 49 the next vacuum package 3 for the next test cycle, as shall be explained in more detail hereafter. The duration of a test cycle of the testing station can be adapted to the cycle of upstream vacuum package production device 17.

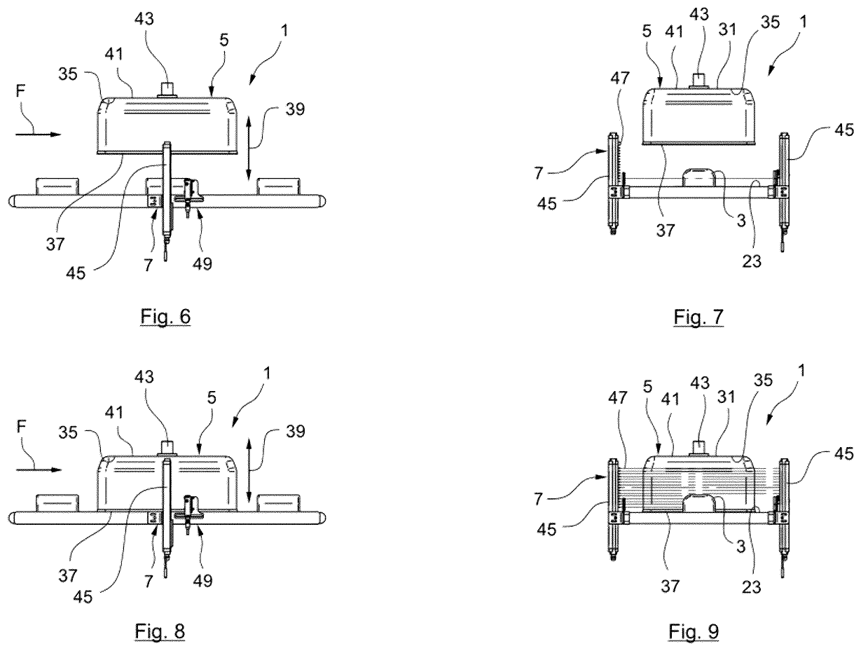

Two further exemplary embodiments for testing for the tightness of vacuum packages 3 shall be explained using FIGS. 6-11 and 12-21 respectively. Vacuum packages 3 to be tested are first made to assume the test position by way of conveyor belt 23. The positioning is effected by light barrier 49, as was already explained with reference to FIGS. 3-5. During the positioning phase of vacuum package 3 to be tested, negative pressure generating device 5 is in a passive state remote from conveyor belt 3 (FIGS. 6 and 7) and the later test room is acted upon at this point in time with the reference pressure, which can be, for example, atmospheric pressure. The movement or motion of housing 31 of negative pressure generating device 5 can be carried out using suitable mechanics and/or electronics.

Once vacuum package 3 to be tested is in the correct position, which is detected by light barrier 49, negative pressure generating device 5 can be activated and housing 31 can be brought into sealing contact with conveyor belt 23 in order to seal the test room in a fluid-tight manner and form a closed evacuation chamber 35. Simultaneously, conveyor belt 23 is stopped (FIGS. 8 and 9). The reference pressure continues to be applied in the test room and the initial spatial dimension of the vacuum package to be tested is determined (initialization state) by way of sensor system 7, in the example of FIGS. 6-11 by optoelectronic sensor unit 45, which can generate a light curtain 47, for generating the first sensor data.

After the first sensor data has been generated, negative pressure generating device 5 lowers the pressure to the test pressure within a given evacuation time during the testing process in which the test room defined by housing 31 is acted upon via port 43 with test pressure that is reduced in comparison to the reference pressure. The test room is closed in a fluid-tight manner by way of the seal on the ring sealing surface 37 facing conveyor belt 23. During the lowering of the pressure in the test room, sensor system 7 (e.g. sensor unit 45) records second sensor data at least once which represents the spatial dimension of vacuum package 3 to be tested during the lowering of the reference pressure to the test pressure.

In the case of a leaky vacuum package 4, as shown schematically in FIG. 11, a change in the spatial dimension of vacuum package 4 arises and is represented by the second sensor data. It can be seen schematically in FIG. 11 that vacuum package 4 has inflated in comparison to initial vacuum package 3 so that its volume and therefore its spatial dimension changes, which can be detected by the second sensor data recorded. By comparing the initial, first sensor data to the second sensor data obtained when negative pressure is applied, a leak in tested vacuum package 3 or 4, respectively, can be inferred in a simple manner and using inexpensive electronics 13, in particular sensor system 7 (e.g. sensor unit 45 and evaluation unit 9).

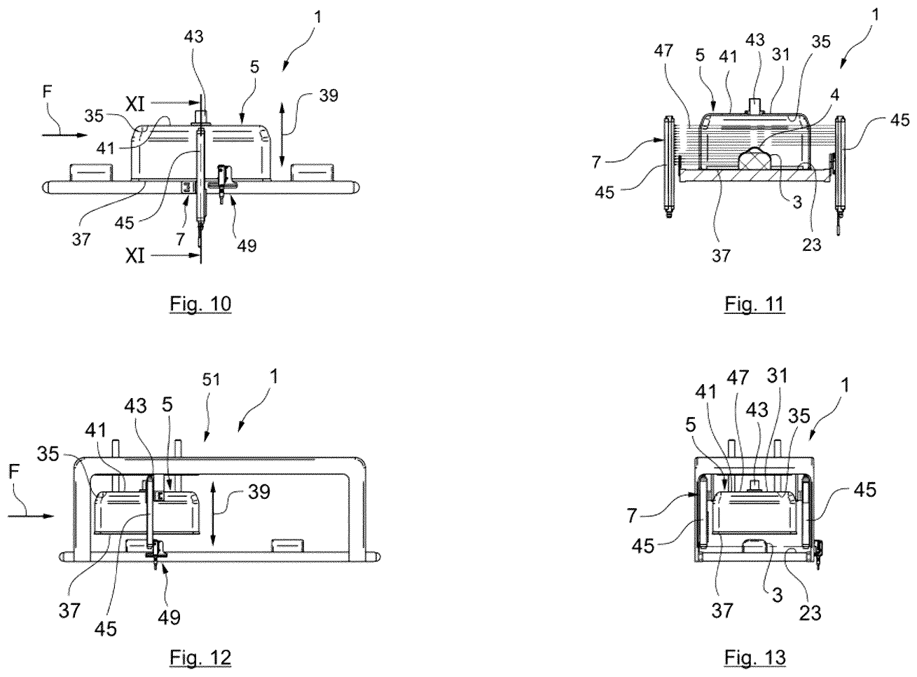

FIGS. 12-21 show a further exemplary embodiment of a testing station 1 according to the invention. To avoid repetition, substantially the differences that arise in relation to the previous embodiments are securely addressed. The main difference between testing station 1 of FIGS. 12-21 and testing station 1 of FIGS. 6-11 is that conveyor belt 3 and therefore the conveyance of further vacuum packages 3 to be tested does not need to be stopped during a testing process (testing cycle). Conveyance by way of conveyor belt 23 can be continuous.

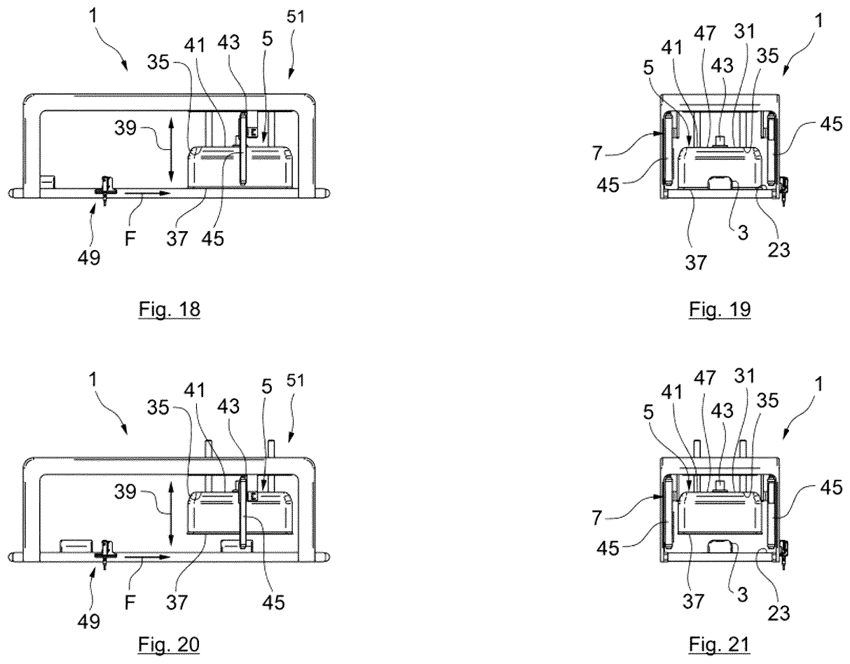

Negative pressure generating device 5 is configured and designed such that it moves along with moving conveyor belt 23 for carrying out a testing process (see in particular the comparison of FIGS. 16 and 18). A gantry robot 51 is provided to move negative pressure generating device 5 and is configured to move negative pressure generating device 5, in particular its housing 31, in accordance with the vacuum package conveyance.

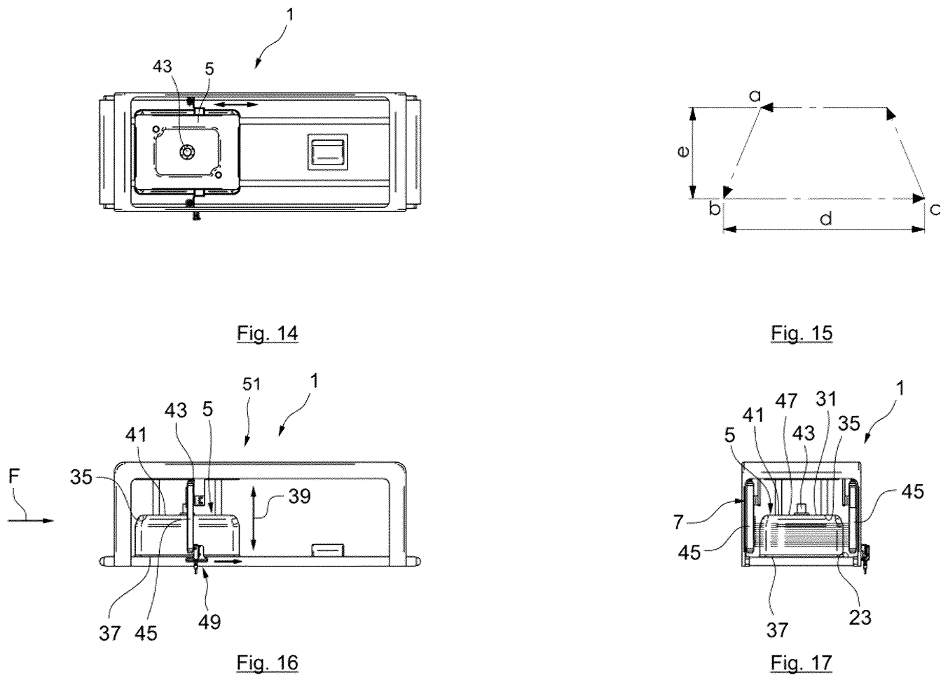

Gantry robot 51, which can be, for example, a 2-axis linear gantry is illustrated using the motion diagram shown in FIG. 15. At the beginning of a testing process, housing 31 of negative pressure generating device 5 is in starting position a (FIGS. 12 and 13). Once a vacuum package 3 to be tested is in the correct position, which is detected and confirmed, for example, by way of light barrier 49 or a similar optoelectronic system, housing 3 is lowered in accordance with an in particular vertical travel path e and moved to a sealing contact position with the continuously moving conveyor belt.

Once the sealing contact with conveyor belt 23 has been established by way of housing 31, first sensor data representing the initial spatial measurement of vacuum package 3 to be tested can be generated by way of sensor system 7 (e.g. sensor unit 45) in the test room which is defined by housing 31 and transport belt 23 and in which the reference pressure prevails. Meanwhile, conveyor belt 23 continues to convey continuously and gantry robot 51 moves housing 31 along in conveying direction F in accordance with the conveying speed of conveyor belt 23.

After the first sensor data has been recorded, the pressure in the test room can be lowered to the test pressure by way of negative pressure generating device 5. The second sensor data is recorded by way of sensor system 7 (e.g. sensor unit 45) at least once while the pressure is lowered. Such second sensor data represents the spatial dimension of the vacuum package at the time of measurement during the testing process. Once the (respective) second sensor data has been recorded, it can be evaluated by evaluation unit 9. During the testing process, housing 31 has travelled in particular horizontal test distance d (compare FIGS. 15 and 20).

Housing 31 can then be raised again by way of gantry robot 51 to assume a passive state or a positioning state, respectively (cf. FIGS. 20 and 21), and a new test cycle can begin. Housing 31 is returned to starting position a (FIG. 12). The duration of a test cycle, the speed of motion of the gantry robot, and the cycle of the vacuum packages to be tested can be matched to one another such that, once housing 31 has moved from its end point c back again to starting point a after a testing process, a further vacuum package 3a to be tested has already been conveyed in by way of conveyor belt 23 so that a new test cycle can be started immediately in which housing 31 is lowered by way of gantry robot 51 onto continuously moving conveyor belt 23. For this purpose, control unit 11 and sensor system 7 (in particular evaluation unit 9) can be matched to one another and communicate with one another.

In the exemplary embodiments of FIGS. 2 to 21, sensor system 7 comprises an optical sensor unit 45 which can detect by way of a light curtain 47 the change in the spatial dimension of vacuum package 3 to be tested. In principle, however, sensor system 7 can also be implemented by way of one or more optoelectronic sensors, by way of one or more electronic image recording unit(s), and/or by way of one or more sensor(s) operating according to the Doppler principle. Sensor system 7 can also contain a combination of the different types of sensors mentioned.

In principle, two-dimensional and three-dimensional image recording units can be used as image recording units. An example of two-dimensional image recording is a charge coupled device (CCD) image sensor which is also used in conventional digital cameras. three-dimensional image recording could be realized, for example, using a depth camera that can measure distances relative to the image plane. A possible example there is a so-called TOF (time of flight) camera which can measure distances using a transit time method. The image sensors do not have to be of a particularly high resolution; it is sufficient to have the image data obtained make changes in the dimension of vacuum packages 3 to be tested be detectable. The image sensors can operate in the optical range but also in the infrared range. Furthermore, when using image sensors, the suitable selection of threshold values can ensure that tight vacuum packages are not incorrectly detected as being leaky packages.

In a further exemplary embodiment, sensor system 7 comprises at least one image recording unit. Each image recording unit there records an image of one or more testing vacuum packages 3 in the initialization state and during the testing process. The images thus obtained are supplied to evaluation unit 9 which detects a leak in at least one of the one or more vacuum packages based on a comparison of the images recorded in the initialization state and during the testing process. The image data of the images in the initialization state and during the testing process can optionally be subjected to filtering and/or image processing in evaluation unit 9, which enhances the differences between the images recorded in the initialization state and during the testing process. The filtering can be, for example, an edge filter that makes the contours of vacuum package 3 easier to recognize in the images. Image processing can comprise, for example, the formation of difference images from corresponding image data in the initialization state and during the testing process. The image recording unit can there realize two-dimensional or three-dimensional image recording. The image plane can there be set, for example, from above and substantially perpendicular to the plane of conveyor belt 23. However, it is also conceivable, like in the exemplary embodiments in FIGS. 2-21, to set up the image plane to be transverse to conveying direction F, as is the case with sensor unit 45. Multiple image sensors can also record one or more vacuum packages 3 to be tested from different viewing angles. If, for example, a TOF camera is used, then the determined distances in the images in the initialization state and during the testing process can be compared with one another and evaluation unit 9 can detect a leaking vacuum package 3 where the deviations in the distances in the images in the initialization state and during the testing process exceed a predetermined threshold value.

Optionally, sensor system 7 can also comprise a projection unit that generates a light grid having a predetermined raster with which the one or more vacuum packages 3 are acted upon. In an exemplary further development, the image recording unit records this light grid. Evaluation unit 9 can infer the tightness of the one or more vacuum packages based on a change of the raster of the light grid in the images in the initialization state and during the testing process. The test for tightness in a test region can be based on a comparison of the image data of the images in the initialization state and during the testing process in the test region. The differences in the image data can be determined, for example, using a difference image between corresponding image data in the initialization state and during the testing process. In an exemplary implementation, evaluation unit 9 can infer that at least one vacuum package is leaking if the entropy of the image data in the difference image is greater than a corresponding threshold value indicating a leaking vacuum package.

In the exemplary embodiments of FIGS. 2 to 21, sensor system 7, in particular sensor unit 45, is arranged outside housing 31. Accordingly, the housing is transparent, or transparent in part, respectively, so that vacuum package 3 in the interior of the test room can be acted upon with light curtain 47. In principle, however, it is also conceivable that parts of sensor system 7, in particular the sensor unit with one or more sensors, is mounted in the interior of housing 31 and records at least one vacuum package 3 to be tested. In this case, housing 31 does not have to be configured to be transparent at least in part. In particular, this configuration is also relevant for implementations in which the test room does not need to be enclosed by a separate housing 31, for example, if testing station 1 is integrated into a vacuum package system (e.g. deep-drawing device). It must be ensured in such a case that the sensor unit of sensor system 7 operates reliably also when the test pressure is applied. Another alternative is to have the sensor type of the sensor unit be selected and matched to the material of housing 31 such that the sensor unit can record vacuum package 3 also in the interior of housing 31, even if the sensor unit is arranged outside housing 31. For example, the sensor unit can comprise one or more sensors that operate according to the Doppler principle, such as microwave sensors.

As already indicated, the sensor unit of sensor system 7 does not necessarily have to be aligned to be transverse to conveying performance 23 of vacuum packages 3. Basically, it is only necessary to ensure that the sensor unit can record vacuum packages 3 in the initialization state and during the testing process so that a change in the spatial dimension of vacuum packages 3 can be detected based on the sensor data recorded. The sensor unit could also be aligned, for example, to be perpendicular to the plane of conveyor device 23, or several sensors of the sensor unit could record vacuum packages 3 in the test room from different angles.

As mentioned several times, testing station 1 can also be configured to test several vacuum packages 3 for tightness simultaneously in a testing cycle. In such a case, several vacuum packages 3 are simultaneously arranged within housing 31 defining evacuation chamber 35, evacuation chamber 35 is evacuated, and all of several vacuum packages 3 are tested simultaneously by way of sensor system 7. In the exemplary embodiment of FIGS. 2-21, for example, several vacuum packages 3 could be tested simultaneously using sensor unit 45 if, for example, they were positioned to be transverse to conveying direction F on conveyor belt 23. In such a case, however, sensor unit 45 could only detect whether one of several vacuum packages 3 is leaking, without being able to distinguish which of packages 3 is not tight. In order to increase the number of vacuum packages 3 tested simultaneously, several sensor units 45 could in principle also be used in testing station 1 and could be arranged with predetermined spacings in a direction opposite to conveying direction F. Vacuum packages 3 would have to be positioned on conveyor belt 23 according to these spacings so that each of sensor units 45 can record an individual vacuum package 3. In this case, sensor system 7 could distinguish which of vacuum packages 3 is leaking and then selectively initiate the discharge of individual leaking vacuum packages 3 using appropriate control signals. In this exemplary embodiment, several vacuum packages 3 could alternatively be arranged to be transverse to conveying direction F and—in conveying direction F—in several rows, where each row could be tested by way of a sensor unit 45. Sensor system 7 of testing station 1 can then be enabled to individually record different test positions or test regions, each of which is associated with at least one of vacuum packages 3.

When using an image recording unit as a sensor unit of sensor system 7, different test positions or test regions could be associated with different regions in the image data. In such a case, evaluation unit 9 could compare the corresponding regions in the image data in the initialization state and during the testing process in order to determine for each image region and therefore for each test position or test region whether a leaking vacuum package 3 exists in the respective region. If each test position or each test region corresponds to an individual vacuum package 3, then it can be determined with sensor system 7 which of vacuum packages 3 being tested simultaneously is or are leaking and control signals can cause appropriate measures, such as the discharge of leaking vacuum packages 3, to be initiated.

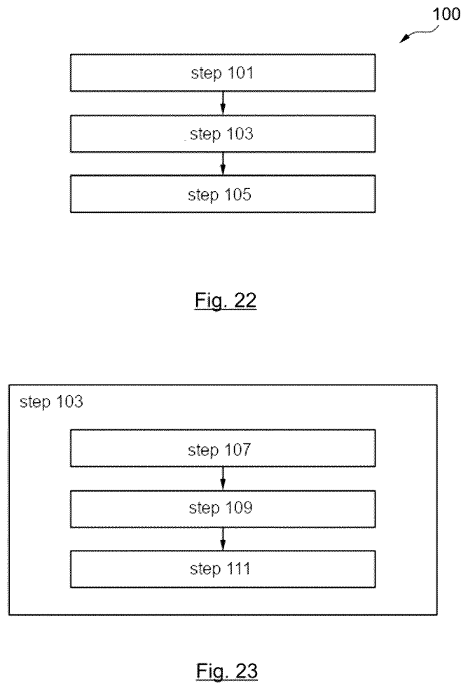

FIGS. 22 and 23 show schematic flow diagrams to illustrate exemplary embodiments of testing methods 100 according to the invention. The individual steps of the flowcharts can be implemented, for example, as program code that consists of commands. The commands implementing the individual method steps can be, for example, stored on a non-volatile storage medium (e.g. a read-only memory (ROM), a flash memory module, a solid-state drive (SSD) or the like). The execution of the commands by a computing unit or a processor unit results in the individual steps of the method being carried out by the respective units of testing station 1. Evaluation unit 9 can form such a computing unit.

In step 101, vacuum package 3 to be tested, which has an initial spatial dimension at a reference pressure, is subjected to a test pressure that is reduced in comparison to the reference pressure. Subsequently, in step 103, a change in the spatial dimension of vacuum package 3 relative to the initial spatial dimension of vacuum package 3 is recorded during the lowering of the pressure from the reference pressure to the test pressure. Steps 101 and 103 can comprise that a sensor system 7 in testing station 1 records the spatial dimension of one or more vacuum packages 3 in a test room at reference pressure and during the lowering of the pressure to the test pressure, as previously described in detail.

It is thereafter determined in step 105 whether the tested vacuum package 3 is leaking. This determination in step 105 is based on the recorded change in the spatial dimension of the one or more vacuum packages 3 that are being tested. The change in the spatial dimension can there be detected in different ways and with a different sensor system 7.

For example, the detection of the change in the spatial dimension of the one or more vacuum packages 3 to be tested simultaneously can comprise the following steps of: First sensor data is first recorded by way of a sensor system 7. This first sensor data represents the initial spatial dimension of vacuum package(s) 3 to be tested, recorded in an initialization state when a reference pressure is applied (step 107). Step 102 can also be omitted if the initial spatial dimension of the one or more vacuum packages 3 is known, for example, can be read out from a memory or is specified by the operating staff. Subsequently, second sensor data is recorded using sensor system 7 and represents the spatial dimension of vacuum package(s) 3 to be tested during a testing process (following the initialization state) in which the pressure in the test room is lowered to the test pressure (step 109). Finally (step 111), the recorded first sensor data (or the corresponding known data that represents the initial spatial dimension) and the second sensor data recorded during the lowering of the pressure from the reference pressure to the test pressure are compared with one another in order to record a change in the spatial dimension of vacuum package 3.

Steps 109 and 111 can also be repeated several times within the time period in which the reference pressure is reduced to the test pressure. This can be done, for example, by carrying out steps 109 and 111 at predetermined intervals or continuously while the reference pressure is reduced to the test pressure. If, in an iteration of steps 109 and 111, a change in the spatial dimension of one or more vacuum packages 3 indicating a leaky vacuum package is detected, a control signal can be output that indicates the presence of a leaky package. Alternatively, the control signal can be output only when a number of (immediately consecutive or not immediately consecutive) comparisons of the data in the iterations of step 111 exceeding a threshold value greater than zero, respectively indicate a change in the spatial dimension of a vacuum package that indicates one or more leaky vacuum packages 3. Optionally, a test cycle can be ended or aborted when a leaky package has been detected and the control signal has been output. Furthermore, a control signal can be output in step 105 which indicates that no leakage of a vacuum package has been detected if no leaking vacuum package has been detected in step 103 or steps 109 and 111, respectively.

As already stated, this comparison of the sensor data can comprise forming difference data from the first and second sensor data, where the difference data is evaluated by an evaluation unit 9 in order to detect a leaky vacuum package 3. Evaluation unit 9 can compare the difference data with a threshold value or check for deviations from reference data that indicate a leak in a tested vacuum package 3. If a leaky vacuum package 3 has been detected by evaluation unit 9, then this can be indicated or output by evaluation unit 9 by outputting an alarm signal and/or control signal for taking further (automated or manually performed) measures.

### LIST OF REFERENCE CHARACTERS

1 testing station
3 vacuum package
4 leaking vacuum package
5 negative pressure generating device
7 sensor system
9 evaluation unit
10 arrow
11 control unit
13 electronics
15 conveying line
17 vacuum package production device
19 conveying system
21 preparation station
23 conveyor belt
25 lock
27 treatment station
29 baffle plate
31 housing
35 evacuation chamber
37 ring sealing surface
39 double arrow
41 upper side
43 port
45 sensor
47 light curtain
49 light barrier
51 gantry robot
53 counter negative pressure generating device
55 vacuum panel
57 testing room
59 underside
61 upper side
63 deflection roller
65 tensioning device
67 motor
69 plate structure
71 port
73 upper side
75 reinforcement strip
77 sheet metal insert
79 evacuation chamber
F conveying direction
100 testing method for vacuum packages
101-111 method step

1. Testing station for testing for the tightness of one or more vacuum packages, where each of the one or more vacuum packages has an initial spatial dimension at a reference pressure, comprising:
a negative pressure generating device which is configured to subject said one or more vacuum packages from the outside to a test pressure that is reduced in comparison to said reference pressure, and
a sensor system which is configured to determine, based on a change in the spatial dimension of at least one of said one or more vacuum packages during the application of said test pressure relative to the respective initial spatial dimension of said one or more vacuum packages, whether at least one of said one or more vacuum packages is leaking,
wherein the testing station is set up to inspect several vacuum packages simultaneously, and
wherein the sensor system is set up to individually detect different test positions or test areas, each of which is assigned to at least one of the one or more vacuum packages, and comprises an evaluation unit which is set up to individually test the tightness of the at least one of the one or more vacuum packages at each test position or in each test area based on the sensor data of the sensor system.

2. Testing station according to claim 1, furthermore comprising a housing that defines a test room in which said one or more vacuum packages are acted upon with said test pressure, wherein said negative pressure generating device is configured to lower said reference pressure to said test pressure in said test room.

3. Testing station according to claim 2, wherein said negative pressure generating device for lowering said reference pressure to said test pressure is configured to evacuate said test room with a volume flow of more than 500 m³/h, more than 700 m³/h.

4. Testing station according to claim 3, wherein said negative pressure generating device is configured to lower the test room from said reference pressure to said test pressure in less than 1 second.

5. Testing station according to claim 2, wherein said negative pressure generating device has a first working state, hereinafter the testing process, in which it lowers said reference pressure to said test pressure in said test room, and a second working state, hereinafter the initialization state, in which it applies said reference pressure in said test room.

6. Testing station according to claim 2, furthermore comprising for said one or more vacuum packages a flexible support, such as a flexible conveyor belt of a conveying system, which interacts with said housing for fluid-tight definition of said test room.

7-9. (canceled)

10. Testing station according to claim 2, wherein said housing is transparent or permeable to microwaves, at least in part.

11. Testing station according to claim 2, furthermore comprising a control unit which is configured to control the operation of said negative pressure generating device according to the respective working state.

12-13. (canceled)

14. Testing station according to claim 2, wherein said housing is mounted to be movable relative to said vacuum package, where said control unit is configured to move said housing towards said vacuum package for assuming the first working state in such a way that it surrounds said one or more vacuum packages, and to move it away from said vacuum package for assuming a third working state, hereinafter the passive state.

15. (canceled)

16. Testing station according to claim 1, wherein said evaluation unit is configured to output a control signal if a leak is detected in at least one of said one or more vacuum packages indicating the detection of a leak in at least one of said one or more vacuum packages.

17-20. (canceled)

21. Testing station according to claim 1, wherein said sensor system comprises several optical sensors, where each of said optical sensors is configured to generate a light curtain and to act upon at least one of several vacuum packages with said light curtain.

22. (canceled)

23. Testing station according to claim 1, wherein said sensor system comprises at least one image recording unit, where each image recording unit is configured to record and to supply to said evaluation unit at least one image of said one or more vacuum packages in the initialization state and during the testing process, and
wherein said evaluation unit is configured to detect a leak in at least one of said one or more vacuum packages based on a comparison of the images recorded in the initialization state and during the testing process.

24-30. (canceled)

31. Testing station according claim 6, furthermore comprising a counter negative pressure generating device which is associated with the support and which is configured to apply a counter negative pressure to an underside of said support facing away from said test room, where said counter pressure is greater in magnitude than said test pressure.

32-33. (canceled)

34. Method for testing for the tightness of one or more vacuum packages, wherein each of said one or more vacuum packages has an initial spatial dimension at a reference pressure, comprising:
lowering a pressure to which said one or more vacuum packages are subjected from a reference pressure to a test pressure that is reduced relative to said reference pressure;
recording a change in the spatial dimension of at least one of said one or more vacuum packages during the lowering of said test pressure relative to the respective initial spatial dimension of said one or more vacuum packages;
determining whether at least one of said one or more vacuum packages is leaking based on the recorded change in the spatial dimension; and
upon detection of a leakage of at least one of the one or more vacuum packages, outputting control signal which identifies each leaking package among the plurality of vacuum packages,
wherein the plurality of vacuum packages are each associated with a test position or a test area in the detection field of the sensor system and the control signal identifies the corresponding test position or the corresponding test area of the leaking package for each leaking package.

35. Method according to claim 34, wherein recording a change in the spatial dimension of at least one of said one or more vacuum packages during the lowering of said pressure relative to the respective initial spatial dimension of said one or more vacuum packages comprises:
recording first sensor data of a sensor system which represents the initial spatial dimension of said one or more vacuum packages in an initialization state when said reference pressure is applied;
recording second sensor data of a sensor system which represents the spatial dimension of said one or more vacuum packages during a testing process that temporally follows the initialization state, where said reference pressure is lowered to said test pressure during the testing process; recording a change in the spatial dimension of at least one of said one or more vacuum packages by comparing said first and second sensor data recorded.

36. Method according to claim 35, wherein second sensor data is recorded repeatedly or continuously during the lowering of said reference pressure to said test pressure and said change in the spatial dimension is recorded for at least part of said second sensor data thus recorded.

37. Method according to claim 34, wherein it is determined whether at least one of said one or more vacuum packages is leaking when the comparison of said sensor data indicates that said magnitude of change in the spatial extension exceeds a threshold value.

38-46. (canceled)

47. Method according to claim 1, furthermore comprising:
before lowering said pressure to which said one or more vacuum packages are subjected, applying a counter negative pressure to an underside of an flexible support on which said one or more vacuum packages rest, where said counter negative pressure is greater in magnitude than said test pressure.

48-51. (canceled)

52. Test station for testing the tightness of one or more vacuum packages, each of the one or more vacuum packages having an initial spatial dimensioning at a reference pressure, comprising a vacuum generating device adapted to externally subject the one or more vacuum packages to a test pressure reduced relative to the reference pressure, and a sensor system adapted to determine whether at least one of the one or more vacuum packages is leaking based on a change in the spatial dimension of at least one of the one or more vacuum packages during the test pressurization relative to the respective initial spatial dimension of the one or more vacuum packages; wherein
the sensor system comprises a sensor unit and an evaluation unit, wherein the sensor unit is set up to acquire first sensor data in the initialization state, which represent the initial spatial dimensions of the one or more vacuum packages in the initialization state, and second sensor data during the test process, which represent the spatial dimensions of the one or more vacuum packages during the lowering of the reference pressure to the test pressure,
the evaluation unit is set up to detect a leak in at least one of the one or more vacuum packages based on a comparison of the first and second sensor data,
the sensor unit of the sensor system comprises at least one optical sensor, an optoelectronic sensor, an electronic image acquisition unit and/or a sensor operating according to the Doppler principle, which are set up to acquire first and second sensor data, and
whereby either
the sensor system comprises one or more optical sensors, each optical sensor comprising a plurality of one-dimensionally arranged elements which generate a light curtain from a plurality of light beams arranged at a predetermined distance and which act on one or more vacuum packages with the light curtain, and light detectors which are assigned to the individual light beams and which detect an interruption of the individual light beams, wherein the sensor system is set up to detect, based on a change in the number of interrupted light beams in the initialization state and during the test process, the change in the dimensioning of at least one of the one or more vacuum packs, or
the sensor system further comprises a plurality of optical sensors which generate a light grid with a predetermined grid and which apply the light grid to at least one of the one or more vacuum packs.

53. A method of checking the tightness of one or more vacuum packages, each of the one or more vacuum packages having an initial spatial dimensioning at a reference pressure, comprising:
lowering a pressure to which the one or more vacuum packages are subjected from a reference pressure to a test pressure reduced relative to the reference pressure;
detecting a change in the spatial dimensioning of at least one of the one or more vacuum packages during the reduction in pressure relative to the respective initial spatial dimensioning of the one or more vacuum packages; and
determining whether at least one of the one or more vacuum packages is leaking based on the detected change in spatial dimensioning,
where either the following steps are taken:
applying a light curtain consisting of a plurality of light beams arranged at a predetermined distance to the one or more vacuum packages in an initialization state when the reference pressure is applied;
exposing the one or more vacuum packages to the light curtain during the testing process; and
detecting a change in the dimensioning of at least one of the one or more vacuum packages based on a change in the number of interrupted light beams in the initialization state and during the testing process, or
capturing at least one image of the one or more vacuum packages in the initialization state and during the inspection process, and
detecting a leak in at least one of the one or more vacuum packages based on a comparison of the images captured in the initialization state and during the inspection process,
wherein the captured images detect a light grid with a predetermined grid applied to the one or more vacuum packages, and the tightness of the one or more vacuum packages is inferred on the basis of a change in the grid of the light grid in the images in the initialization state and during the test process.
